(19) United States
(12) Patent Application Publication
(10) Pub. No.: US 2004/0240752 A1
(43) Pub. Date: Dec. 2, 2004

(54) Method and system for remote and adaptive visualization of graphical image data

(76) Inventors: Andrew Bruno Dobbs, Vallakra (SE); Niels Husted Kjaer, Hedehusene (DK); Alexander Dimitrov Karaivanov, Herlev (DK); Morten Sylvest Olsen, Kobenhavn NV (DK)

Correspondence Address: HARNESS, DICKEY & PIERCE, P.L.C., P.O. BOX 8910, RESTON, VA, 20195, US

(21) Appl. No.: 10/843,420

(22) Filed: May 12, 2004

Related U.S. Application Data
(60) Provisional application No. 60/469,830, filed on May 13, 2003.

(51) Int. Cl. G06K 9/36

(52) U.S. Cl. 382/276

(57) ABSTRACT

The invention relates to a method and system for remote visualization and data analysis of graphical data, in particular graphical medical data. A user operates a client machine 21 such as a thin client, a PC, a PDA, etc. and the client machine is connected to a server machine 20 through a computer network. The server machine runs an adaptive streaming module (ASM) which handles the connection between the client and the server. All data and data applications are stored and run on the server. A user at the client side requests data to be shown on the screen of the client, this request 24 is transferred to the server. At the server side the request is interpreted as a request for a particular screen image, and a data application generates the requested screen image and estimates a present available bandwidth 26 of a connection between the client and the server. Based on the estimated available bandwidth, the generated screen image is compressed using a corresponding compression method so that a compressed screen image is formed. The screen image may also be encrypted. The compressed (and possible encrypted) screen image is forwarded 22 to the client, and shown on the screen of the client 23. The compression method depends foremost upon the available bandwidth, however also the type of client machine 28, the type of request, etc. may be taken into account.

### FIELD OF THE INVENTION

The present invention relates to a method and system for remote visualization and data analysis of graphical data, in particular the invention relates to remote visualization and data analysis of graphical medical data.

### BACKGROUND OF THE INVENTION

In order to visualize a variety of internal features of the human body, e.g. the location of tumors, a variety of medical image scanners has been developed. Both volume scanners, i.e. 3D-scanners, such as: Computed Tomography (CT), Magnetic Resonance Imaging (MRI), Ultrasound (US), Positron Emission Tomography (PET), and Single Photon Emission Computed Tomography (SPECT), as well as 2D-scanners, such as: Computed Radiography (CR) and Digital Radiography (DR) are available. The scanners utilize different biophysical mechanisms in order to produce an image of the body. For example, the CT scanner detects X-ray absorption in a specific volume element of the patient who is scanned, whereas the MRI scanner uses magnetic fields to detect the presence of water in a specific volume element of the patient who is scanned. Both these scanners provide slices of the body, which can be assembled to form a complete 3D image of the scanned section of the patient. A common factor of most medical scanners is that the acquired data sets, especially with the 3D-scanners, are quite large, consisting of several hundreds of megabytes for each patient. Such large data sets require significant computing power in order to visualize the data, and especially to process and manipulate the data. Furthermore, transmitting such image data across common networks presents challenges regarding security and traffic congestion.

The image data generated with medical image scanners are generally managed and stored via electronic database systems under the broad category of Picture Archiving and Communications Systems (PACS systems) which implement the Digital Imaging and Communications in Medicine standard (DICOM standard). The scanner is connected to a central server computer, or a cluster of server computers, which stores the patient data sets. On traditional systems the data may then be accessed from a single or a few dedicated visualization workstations. Such workstations are expensive and can therefore normally only be accessed in dedicated diagnostic suites, and not in clinicians offices, hospital wards or operating theaters.

Another type of less expensive system exists in which a general client-server architecture is used. Here a high-capacity server with considerable computing power is still needed, but the central server computer may be accessed from a variety of different client types, e.g. a thin client. In such systems a visualization program is run on the central server, and the output of the program is via a network connection routed to a remote display of the client. One example of a client-server system is the OpenGL Vizserver™ system provided by Silicon Graphics, Inc. (http://www.sgi.com/software/vizserver/). The system enables clients such as Silicon Graphics® Octane®, and PC based workstations to access the rendering capabilities of an SGI® Onyx® server. In this solution, special software is required to be installed at the client side. This not only limits the type of client, which may be used to access the server, but also adds additional maintenance requirements, as the Vizserver™ client software must be installed locally on each client workstation. Further more, the Vizserver™ server software does not attempt to re-use information from previously sent frames. It is therefore only feasible to run such a system if a dedicated high-speed data network is available. This is often not the case for many hospitals; furthermore installation of such a network is an expensive task.

In the U.S. Pat. No. 6,014,694 a system for adaptively transporting video over networks wherein the available bandwidth varies with time is disclosed. The system comprises a video/audio encoder/decoder that functions to compress, code, decode and decompress video streams that are transmitted over the network connection. Depending on the channel bandwidth, the system adjusts the compression ratio to accommodate a plurality of bandwidths. Bandwidth adjustability is provided by offering a trade-off between video resolution, frame rate and individual frame quality. The raw video source is split into frames where each frame comprises a multitude of levels of data representing varying degrees of quality. A video client receives a number of levels for each frame depending upon the bandwidth, the higher the level received for each frame, the higher the quality of the frame. Such a system will only work optimally if an already known data stream is to be sent a number of times, as in the case with video streaming. If the data stream is unique each time it is to be sent, the system generates a huge amount of redundant data for each session, and furthermore, the splitting into frames is not possible before the request is received, thus computing power is occupied for generating redundant data.

### DESCRIPTION OF THE INVENTION

It is an object of the present invention to overcome the problems related to remote visualization and manipulation of large digital data sets.

According to a first aspect the invention provides a method for transferring graphical data from a first device to an at least second device in a computer-network system, the method comprises the steps of:

generating a request for a screen image,

in the first device, upon receiving the request for the screen image:

generating the requested screen image,

estimating a present available bandwidth of a connection between the first and the at least second device,

based on the estimated available bandwidth, compressing the generated screen image using a corresponding compression method so that a compressed screen image is formed, and

forwarding the compressed screen image to the at least second device.

The graphical data may be any type of graphical data but is preferably medical image data, e.g. data acquired in connection with a medical scanning of a patient. The graphical data is stored on a first device that may be a central computer, or a central cluster of computers. The first device may comprise any type of computer, or cluster of computers, with the necessary aggregate storage capacity to store large data sets which, e.g., arise from scanning of a large number of patients at a hospital. The first device should furthermore be equipped with the necessary computing power to be able to handle the demanding tasks of analyzing and manipulating large 3D data sets, such as a 3D image of a human head, a chest, etc.

The at least second device can be any type of computer machine equipped with a screen for graphical visualization. The term visualization should be interpreted to include both 2D visualization and 3D visualization. The at least second device may, e.g., be a thin client, a wireless handheld device such as a personal digital assistant (PDA), a personal computer (PC), a tablet PC, a laptop computer or a workstation. The at least second device machine may merely act as a graphical terminal of the first device. The at least second device may be capable of receiving request actions from a user and transferring the requests to the first device, as well as receiving and showing screen images generated by the first device. The screen of the at least second device can in many respects be looked upon as a screen connected to the first device.

An action is requested, e.g. by the user of the at least second device, or by a program call. The action may, e.g., result in that a list of possible choices may be shown on the screen of the at least second device, or the action may, e.g., result in that an image related patient data may be shown on the screen of the at least second device. The request may be based upon user instructions received from user interaction events such as keystrokes, mouse movements, mouse clicks, etc.

Upon receiving a request, the first device interprets the request in terms of a request for a specific screen image. The first device obtains the relevant patient data from a storage medium to which it is connected. The storage medium may be any type of storage medium, such as a hard disk. A screen image is generated as a result of the request. The present bandwidth of the connection is estimated, and based on the estimated available bandwidth and the type of the request, the screen image is compressed using a corresponding compression method. The first device forwards the compressed screen image to the at least second device.

The first device may, however, also without receiving a request from the at least second device generate a non-requested screen image. The non-requested screen image may be based upon relevant patient data, or the non-requested screen image may be unrelated to patient data or any request made by the user. The non-requested screen image may be generated due to instructions present at the first device.

The generation of the screen image may further be conditioned upon a type of the at least second device. If, e.g., the at least second device is a PDA it may be redundant to generate a high-resolution image, since the PDA's available today are limited in their resolution. Therefore the same images generated to a PDA and a thin client, may be generated with lower screen resolution in the case of the PDA than in the case of the thin client.

The compression method may further be conditioned upon a type of the request. Compression of a graphical image may involve a loss, i.e. the image resulting after a compression decompression process is not identical to the image before the compression decompression process, such methods are normally referred to as lossy compression methods. Compression methods that involve a loss are usually faster to perform and the images may be compressed to a higher rate. The type of request may be taken into account in situations where it is important that the decompressed image is lossless, or in situations where a loss is unimportant. The type of the request may be such as: show an image, rotate an image, zoom in on an image, move an image, etc.

The compression method may further be conditioned upon a type of the at least second device. Especially the computing power of the at least second device may be taken into account. If, e.g., the at least second device is equipped with a computing power so that the task of decompression is estimated to be too time consuming, a different and less demanding compression method may be used.

Since the system may be used for transferring delicate personal information across a data network, it may be important that the transferred data may be encrypted. Therefore, the first device may comprise means for encrypting the screen image before it is sent to the at least second device. Likewise, the at least second device may possess means for decrypting the received screen images before a screen image is generated on the screen of the at least second device. Furthermore, the system may include a feature where the user manually sets the level of encryption, or the system may automatically set an appropriate encryption level. The time it takes to decrypt the received screen images may depend on the processing means of the at least second device machine, especially handheld devices may be limited in processing power. In certain cases it may therefore be a limiting factor to use demanding encryption routines. The encryption routine used for encrypting the data, may therefore be dependent upon the type of the at least second device.

In addition to the image data, the applications for data analysis, data manipulation and data visualization may be stored on the first device, and may be run from the first device. The applications may also be stored on and may be run from a device that is connected to the first device via a computer network connection. A multitude of applications may be accessible from the first device. The application may include software which is adapted to manipulate both 3D graphical medical data such as data from: MRI, CT, US, PET, and SPECT, as well as 2D graphical medical data such as data from: CR and DR, as well as data from other devices that produce medical images. The manipulation may be any standard manipulation of the data such as rotation, zooming in and out, cutting an area, or subset of the data, etc. The manipulation may also be less standard manipulation, or it may be unique manipulation specially developed for the present system.

In order to obtain a flexible system different compression methods may be used. The compression method may either be selected manually at session start or may be chosen automatically by the software. The different compression methods are applied according to the required compression rate. Compression methods may differ in compression time, compression rate as well as, which type of data they are most suitable for. A variety of compression method may be used, both standard methods, as well as methods especially developed for the present system.

An example of a special compression method is the so-called Gray Cell Compression (GCC) method, where an RGB-color graphical image or a gray-scale graphical image is compressed. The compression method comprises the steps of:

subdividing the graphical image into cells containing 4×4 pixels,

determining an average cell color for each cell,

in the case that the average cell color is a gray-scale color, 1 bit is used to mark the cell as gray scaled and 7 bits are used to represent the gray-scale color, or

in the case that the average cell color is not a gray-scale color, 1 bit is used to mark the cell as non-gray scaled and 15 bits are used to represent the color.

The GCC method is especially well suited for compressing images where a large fraction of the image is gray scale. The GCC method is therefore well suited for compression of medical images since many medical objects may often be imaged in gray scale.

Upon initiation of a session, a session manager at the first device site may create and maintain a session between the at least second device machine and the first device and upload control components to the at least second device. The at least second device may be a computer without an operating system (OS), e.g. a thin client. In this case an OS may be uploaded, so that the at least second device becomes capable of accepting and sending request actions, as well as receiving and showing screen images generated by the first device. However, the at least second device may also be a computer with an OS, e.g. a PDA or a PC. For these machines an OS is already functioning on the at least second device, and in this case it may be necessary only to upload a computer application to enable a session. A session may, however, also be created and/or maintained without uploading a computer application from the first device to the at least second device. For example, it may suffice to allow the at least second device to receive screen images from the first device. It is not necessary to run a computer application on the at least second device in order to receive, view and/or even manipulate screen images on an at least second device.

A frame sizer may be present which sets the frame buffer resolution of the at least second device in accordance with the detected available bandwidth, and optionally also in accordance with specifications of the at least second device. That is, if the detected bandwidth is low, the frame buffer resolution may be set to a low value, and the screen image may be generated according to the frame buffer resolution. Setting the frame buffer to a low resolution is a fast way of compressing the data. The graphical hardware of most computer systems possess the functionality that if a screen image with a lower resolution than the screen resolution is received, the screen image will automatically be blown up to fill the entire screen. The final screen output on the at least second device is naturally limited in resolution in this case. In the case that the detected bandwidth is acceptable, the frame buffer resolution may be set to the screen resolution of the at least second device. In this case, more bandwidth is occupied, but full resolution is sustained. The specifications of the at least second device may be taken into account if the at least second device is, e.g. a PDA, since the screen resolution of PDA's which are available today is limited. It would be a waste of bandwidth to transfer an image with a resolution that is too high, only for it to be down sampled at the at least second device.

An object subsampler which sets the visualization and rendering parameters in accordance with the detected available bandwidth, and optionally also in accordance with the specifications of the at least second device may be present. The color depth of the generated screen image may be varied, 8 bit colors may be used while the bandwidth is low, and 16, 24 or 32 bits may be used if the bandwidth permits it. Also the computing power of the at least second device may be taken into account. The time it takes to decompress the received screen images may depend on the processing means of the at least second device machine, especially handheld devices may be limited in processing power. In certain cases it may therefore be faster not to compress, or only slightly compress, the screen images.

The sized, subsampled, compressed and possibly encrypted data is transferred by an I/O-manager at the first device side to an I/O-manager at the at least second device side, which also handles the transferring of the user-interactions to the first device.

In many instances the requested screen image will only contain a small change from the screen image which is already present on the at least second device screen. In this situation it may be advantageous that the screen image generated at the at least second device side is either based on a screen image received from the first device, on the content of a frame buffer at the at least second device side, or on a combination of the received screen image and the contents of the frame buffer. That is, the received screen image contains changes to the previously sent screen image, so that the displayed screen image is a superposition of the previously displayed screen image available through the at least second device's frame buffer, and the received image changes.

Most networks are shared resources, and the available bandwidth over a network connection at any particular instant varies with both time and location. The present available bandwidth is estimated and the rate with which the data is transferred is varied accordingly. When no request actions are received no screen frames are sent to the at least second device, the at least second device refreshes the screen from the frame buffer of the at least second device in this case. Therefore, the network connection occupies variable amounts of bandwidth.

Many hospitals, clinics or other medical institutions already have a data network installed, furthermore the medical clinician may sit at home or at a small medical office without access to a high capacity network. It is therefore important that the at least second device and first device may communicate via a number of possible common network connections, such as an Internet connection or an Intranet connection, e.g. an Ethernet connection, either through a cable connection or through a wireless connection. Especially, the second device and the first device may communicate through any type of network, which utilizes the Internet protocol (IP) such as the Internet or other TCP/IP networks. The second device and the first device may communicate both through dedicated and non-dedicated network connections.

The graphical data may be graphical medical data based on data that conforms to the Digital Imaging and Communications in Medicine standard (DICOM standard) implemented on Picture Archiving and Communications Systems (PACS systems). Most medical scanners support the DICOM standard, which is a standard handling compatibility between different systems. Textual data may be presented in a connection with the graphical data. Preferably the textual data is based on data which conforms to the Health Level Seven (HL7) standard or the Electronic Data Interchange for Administration, Commerce and Transport (EDIFACT) standard. The interchange of graphical and/or medical data may be based on the International Health Exchange (IHE) framework for data interchange.

According to a second aspect of the invention, a system for transferring graphical data in a computer-network system is provided. The system comprises:

at least a second device equipped with means for registering a user input as well as visualization means for visualizing graphical data,

a first device equipped with:

software adapted to generate screen images,

means for estimating an available bandwidth of a connection between the first and the at least second devices,

software adapted to compress a screen image using a multitude of compression methods so that a compressed screen image is formed, and

means for forwarding the compressed screen image to the at least second device.

The first device may further comprise means for encrypting data to be sent via the computer connection between the first device and the at least second device, and the at least second device may comprise means for decrypting the received data.

The at least second device and the first device may communicate via a common network connection. The first device may be a computer server system and the at least second device may, e.g., be a thin client, a workstation, a PC, a tablet PC, a laptop computer or a wireless handheld device. The first device may be, or may be part of, a PACS system.

### BRIEF DESCRIPTION OF THE DRAWINGS

Preferred embodiments of the invention will now be described in details with reference to the drawings in which:

FIG. 1 shows a schematic view of a preferred embodiment of the present invention;

FIG. 2 shows a schematic flow diagram illustrating the functionally of the Adaptive Streaming Module (ASM);

FIG. 3 shows an example of a rotation and the corresponding bandwidth of a data object;

FIG. 4 illustrates the correspondence between the compression time, the compression method used, and the obtainable compression rate for loss-less compression; and

FIG. 5 illustrates the correspondence between the compression quality, the compression method used, and the obtainable compression rate for lossy compression.

### DETAILED DESCRIPTION OF THE INVENTION

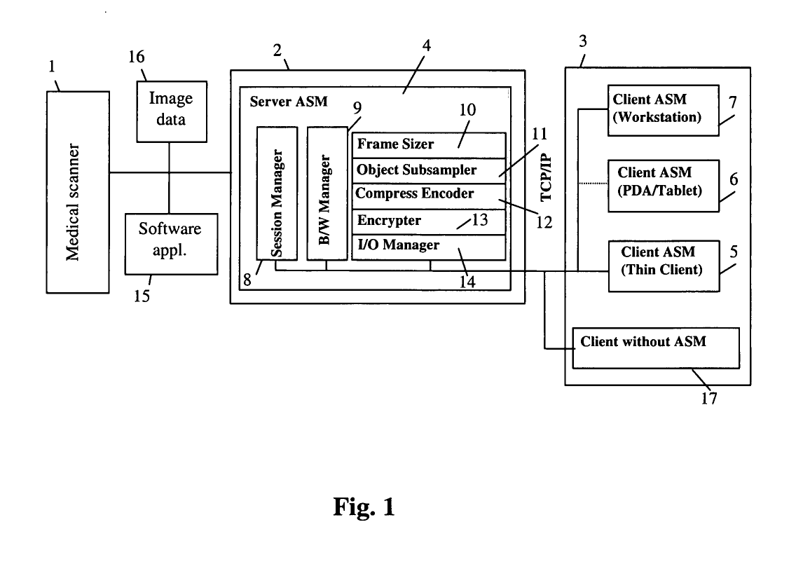

The present invention provides a method and system for transferring graphical data from a first device to an at least second device in a computer-network system. The invention is in the following described with reference to a preferred embodiment where the graphical data is graphical medical data, and where the computer-network system is a client-server system. A schematic view is presented in FIG. 1.

Medical image data is acquired by using a medical scanner 1 that is connected to a server computer 2. A multitude of clients 3 may be connected to the server. The server is part of a PACS system. When a patient has undergone scanning the acquired images 16 may automatically or manually be transferred to and stored on a server machine. Reference is only made to a server or server machine, however, the server may be a separate computer, a cluster of computers or computer system connected via a computer connection. Access to the images may be established at any time thereafter. In addition to the image data, the applications 15 for data analysis and visualization is stored on and may be run from the server machine. The server is equipped with the necessary computing power to be able to handle the demanding tasks of analyzing and manipulating large 3D data sets, such as 3D images of a human head, a chest, etc. All data and data applications 15 for visualization and analysis are stored, operated and processed on the server.

The client 3 can be any type of computer machine equipped with a screen for graphical visualization. The client may, e.g., be a thin client 5, a wireless handheld device such as a personal digital assistant (PDA) 6, a personal computer (PC), a laptop computer, a workstation 7, etc.

An adaptive streaming module (ASM) 4 is used in order to ensure a continuous stream of data between the server and the client. The ASM is capable of estimating the present available bandwidth and vary the rate with which the data is transferred accordingly. The ASM 4 is a part of the server machine 2.

The client may comprise an ASM 5, 6, 7 or it may not comprise an ASM 17. A client ASM is not necessary for the system to work.

The ASM comprises a session manager 8. The session manager creates and maintains a session between the client machine and the server. The session manager 8 uploads control components to the at least second device. For example if the client is a thin client 5, first an operating system (OS) is uploaded, so that the thin client becomes capable of accepting and sending request actions, as well as receiving and showing screen images generated by the server. In the case that the client is a PDA 6 or a PC, an operating system is already functioning on the client, and in this case it may be necessary only to upload a computer program to enable a session.

The ASM further comprises a bandwidth manager 9 that continuously measures the available bandwidth. A frame sizer 10 that sets the frame buffer resolution of the client. An object subsampler 11 that sets the visualization and rendering parameters. A compression encoder 12 that compresses an image. An encrypter 13 that comprise means for encrypting the data before it is sent to the client 3. The sized, subsampled, compressed and encrypted data is transferred by an I/O-manager 14.

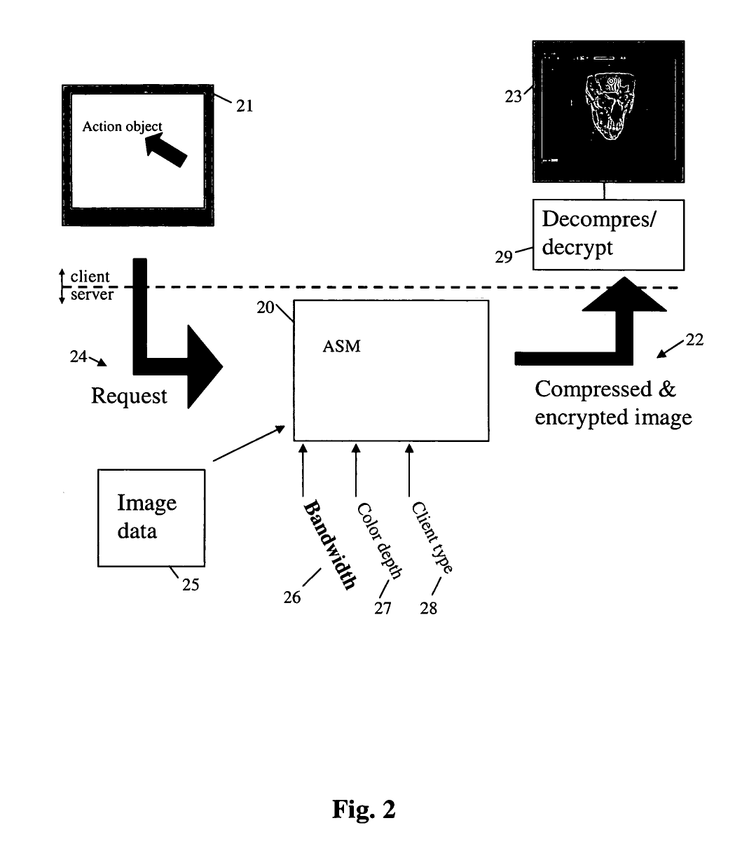

A schematic flow diagram illustrating the functionally of the ASM-module 20 is shown in FIG. 2. The user of the medical data, may, e.g., be a surgeon who should plan an operation on the background of scanned 3D images. The user first establishes a connection from a graphical interface 21, such as a thin client present in his or her office. First the user should log on to the system in order to be identified. Then the user is presented with a list from which the user may request access to the relevant images that are to be presented on the computer screen 23. In another example, the user of the medical data, is a clinician on rounds at a ward in a hospital. In order to facilitate a discussion, or to facilitate a patient's knowledge of his or her condition, the clinician may carry with him a PDA, onto which he can first log on to the system, and subsequently access the relevant images of the patient.

The user of the client is requesting an action, such as a specific image of a patient. The request 24 is sent to the server, which interprets the request in terms of a request for a specific screen image. The server obtains the relevant image data 25 from a storage medium to which it is connected. The present bandwidth 26 of the connection is estimated, and based on the detected available bandwidth and a multitude of other parameters, the screen image is compressed to a corresponding compression rate. As an example two other parameters may be used for generating the screen image. The first parameter may be the color depth 27. If the user requests, e.g., an image of the veins in the brain a 24-bit RGB color depth may be used, but if the user, e.g., requests an image of the cranium an 8-bit color depth may be sufficient. The second parameter may be the client type 28. If the requesting client machine is a thin client a 19-inch screen may be used as the graphical interface. In this case an image with 768 times 1024 pixels may be generated. But if the requesting machine is a PDA, a somewhat smaller image should be generated, e.g. an image with 300 times 400 pixels, since most PDA's are limited with respect to screen resolution.

The screen image is generated, compressed and encrypted 22. The image is transferred to the client machine, where it is first decrypted and decompressed 29 before it is shown on the screen 23 used by the requesting user.

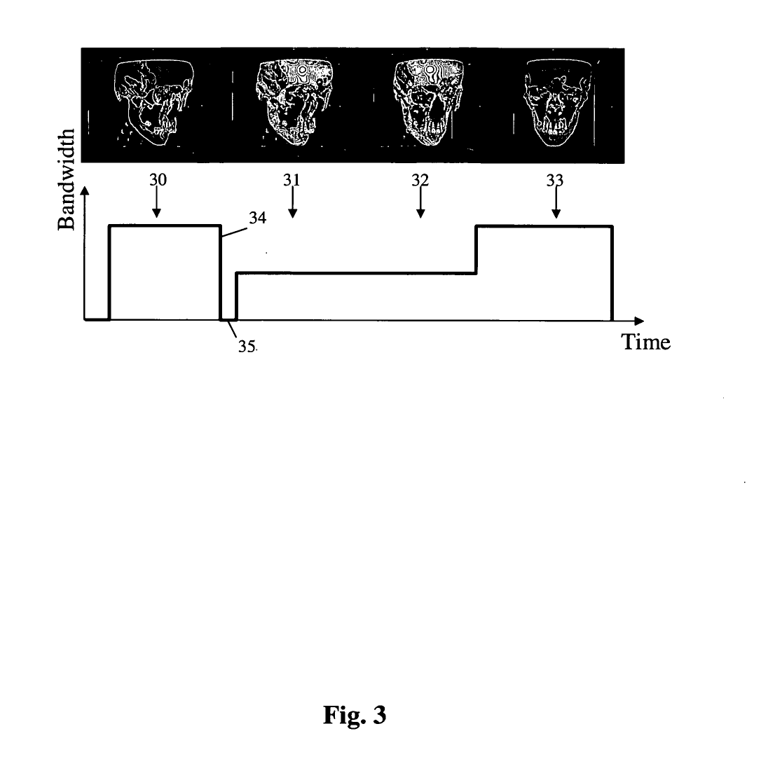

The surgeon may use a multitude of 3D graphical routines, such as rotation, zooming, etc., for example to obtain insight into the location of the object to be operated on. An example of a rotation and the corresponding bandwidth of a data object is given in FIG. 3.

The user has by using the steps explained above in connection with FIG. 2, requested a 3D image of a cranium 30. During the transferring of the image a certain amount of bandwidth 34 has been used, but once the image has been transferred, no, or very little bandwidth, is occupied 35. The user now wants to rotate the image in order to obtain a different view 31, 32, 33. The user may, e.g., click on the image and while maintaining the mouse button pressed move the mouse in the direction of the desired rotation. The type of the request is thus a rotation of the object, and while the mouse button remains pressed, the software treats the request as a rotation.

Compression of a graphical image is a tradeoff between resolution and rate. The lower the resolution that is required, the higher the rate of compression may be used. When rotating an object only an indication of the image is necessary during rotation 31, 32, and not until the rotation has stopped is it necessary to transfer a high quality image 33. The images 31 and 32 are transferred using the steps, as explaining in connection with FIG. 2, but the compression rate of the image is higher resulting in a lower required bandwidth. When the mouse button is released, the transferred image 33 is no longer treated as a rotation, and a lower compression is used.

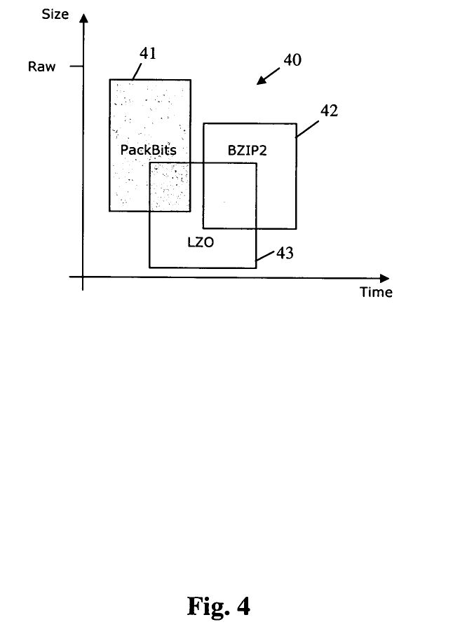

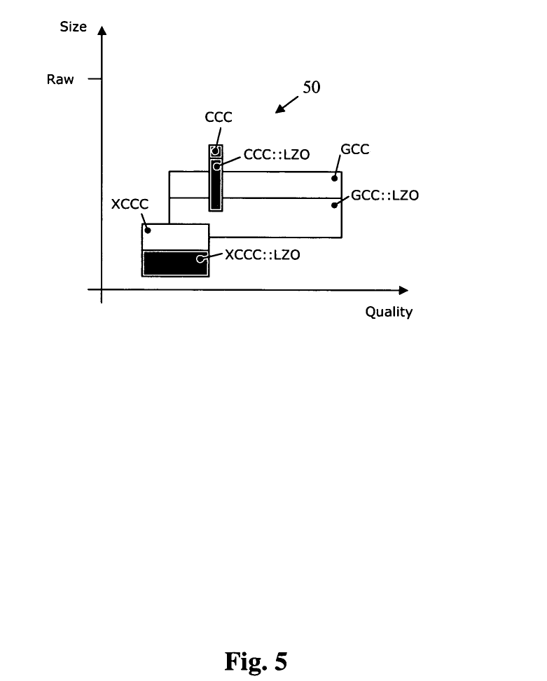

Two types of compression methods are used, loss-less compression methods and loss giving compression methods or lossy compression methods. Different compression methods of both types are used. The different compression methods are applied according to the required compression rate. Compression methods may differ in compression time, compression rate as well as which types of images for which they are most suited. The image compression is determined primarily upon the available bandwidth, but also the type of request is important especially with respect to whether a loss-less or a lossy method is used. An example of the correspondence between the compression time and the compression rate is given in FIG. 4 for three standard loss-less compression methods: PackBits (or Run length encoding), BZIP2 and Lempel-Ziv-Obenhumer (LZO). In FIG. 5, an example is given for the correspondence between the image quality and the compression rate for lossy compression methods, for two standard compression methods: Color Cell Compression (CCC) and Extended Color Cell Compression (XCCC), as well as for a special compression method, the so-called Gray Cell Compression (GCC).

The methods may be used separately or one after the other to obtain a higher compression rate. For example, it is possible to combine a CCC compression with an LZO compression (CCC::LZO).

In FIG. 4, the compression time is compared with the obtainable compression size 40, or the compression rate for the PackBits compression method 41, the BZIP2 method 42 and the LZO method 43. The exact correspondence between compression time and rate depends upon the structure of the image being compressed. This is illustrated by a certain extension of the area occupied by each method.

In FIG. 5, the image quality is compared with the obtainable compression size 50 for a variety of compression methods, single or combined.

In case the image contains large gray-scale areas, it may be beneficial to use a special compression method, which exploits this information. The Gray Cell Compression (GCC) method is an example of such a compression method. GCC is a variant of the standard CCC technique. It uses the fact that cells containing gray-scale pixels have gray-scale average cell colors. This is exploited for a more efficient encoding of the two average cell colors: In case the average cell color is a gray-scale color, 1 bit is used to mark the color as a gray-scale color and 7 bits are used to represent the gray-scale value. In case the average cell color is non gray-scale color, 1 bit is used to mark the cell as non-gray scale color and 15 bits are used to represent the color itself.

The compression rate of the GCC method depends on how large a fraction of the image is gray-scale. In worst case, none of the average colors will be gray-scale colors. In this case, the compression rate is 1:8. In the best case, all average colors are gray-scale colors, yielding a compression rate of 1:12. The advantage of the GCC method is that images containing large gray-scale areas may be transferred at a lower bandwidth and a higher image quality when comparing to the standard CCC method.

Although the present invention has been described in connection with preferred embodiments, it is not intended to be limited to the specific form set forth herein. Rather, the scope of the present invention is limited only by the accompanying claims.

1. A method for transferring graphical data from a first device to an at least second device in a computer-network system, the method comprises the steps of:
generating a request for a screen image,
in the first device, upon receiving the request for the screen image:
generating the requested screen image,
estimating a present available bandwidth of a connection between the first and the at least second device,
based on the estimated available bandwidth, compressing the generated screen image using a corresponding compression method so that a compressed screen image is formed, and
forwarding the compressed screen image to the at least second device.

2. A method according to claim 1, wherein the first device without receiving the request from the at least second device is:
generating a non-requested screen image,
estimating the present available bandwidth of the connection between the first and the at least second device,
based on the estimated available bandwidth, compressing the generated screen image using the corresponding compression method so that the compressed screen image is formed, and
forwarding the compressed screen image to the at least second device.

3. A method according to claim 1, wherein the generation of the screen image is further conditioned upon a type of the at least second device.

4. A method according to claim 1, wherein the compression method used is further conditioned upon a type of the request.

5. A method according to claim 1, wherein the compression method used is further conditioned upon a type of the at least second device.

6. A method according to claim 1, wherein the graphical data that is transmitted between the first device and the at least second device is encrypted.

7. A method according to claim 1, wherein the graphical data is graphical medical data.

8. A method according to claim 1, wherein the graphical data and a multitude of applications for data analysis and visualization are stored/run on the first device, or on a device which is in computer-network connection with the first device.

9. A method according to claim 1, wherein different compression methods are applied according to a required compression rate.

10. A method according to claim 1, wherein the compression method is either selected manually at session start or chosen automatically by the software.

11. A method according to claim 1, wherein control components are uploaded to the at least second device from the first device.

12. A method according to claim 1, wherein a frame sizer at the first device side sets a frame buffer resolution at the at least second device in accordance with the estimated available bandwidth, and optionally also in accordance with specifications of the at least second device.

13. A method according to claim 1, wherein an object subsampler sets the visualization and rendering parameters in accordance with the estimated available bandwidth, and optionally also in accordance with the specifications of the at least second device.

14. A method according to claim 1, wherein an I/O-manager at the first device side sends sized, subsampled, compressed and possibly encrypted frame buffer data to the at least second device, and wherein an I/O-manager at the at least second device side receives the graphical data.

15. A method according to claim 1, wherein the screen image generated at the at least second device side is either based on a screen image received from the first device, on the content of the frame buffer of the at least second device, or on a combination of the received screen image and the contents of the frame buffer.

16. A method according to claim 1, wherein the computer network connection occupies variable amounts of bandwidth, and wherein minimal bandwidth is occupied when data is not transferred from the first device to the at least second device.

17. A method according to claim 1, wherein the at least second device and the first device communicate via a common network connection, such as an Internet connection or an intranet connection, e.g. an Ethernet connection, either through a cable connection or through a wireless connection.

18. A method according to claim 17, wherein the connection protocol is a TCP/IP protocol.

19. A method according to claim 1, wherein the generation of the screen image is based on data which conforms to the DICOM, the HL7 or the EDIFACT standards implemented on PACS systems.

20. A method according to claim 1, wherein an RGB-color graphical image or a gray-scale graphical image is compressed, said compression method comprises the steps of:
subdividing the graphical image into cells containing 4×4 pixels,
determining an average cell color for each cell,
in the case that the average cell color is a gray-scale color, 1 bit is used to mark the cell as gray scaled and 7 bits are used to represent the gray-scale color, or
in the case that the average cell color is not a gray-scale color, 1 bit is used to mark the cell as non-gray scaled and 15 bits are used to represent the color.

21. A computer program adapted to perform the method of claim 1, when said program is run on a computer-network system.

22. A computer readable data carrier loaded with a computer program according to claim 21.

23. A system for transferring graphical data between devices in a computer-network system, said system comprises:
at least a second device equipped with means for registering a user input as well as visualization means for visualizing graphical data,
a first device equipped with:
software adapted to generate screen images,
means for estimating an available bandwidth of a connection between the first and the at least second device,
software adapted to compress a screen image using a multitude of compression methods so that a compressed screen image is formed, and
means for forwarding the compressed screen image to the at least second device.

24. A system according to claim 23, wherein the first device further comprises means for encrypting data to be sent via the computer connection between the first device and the at least second device, and wherein the at least second device comprises means for decrypting the received data.

25. A system according to claim 23, wherein the at least second device and the first device communicate via a common network connection.

26. A system according to claims 25, wherein the network connection is a non-dedicated network connection.

27. A system according to claim 23, wherein the first device is computer server system.

28. A system according to claim 23, wherein the at least second device is a thin client, a work station computer, a PC, a lap top computer, a tablet PC, a mobile phone or a wireless handheld device.

29. A system according to claim 23, wherein the first device is, or is part of, a PACS system.

30. A method according to claim 9, wherein an RGB-color graphical image or a gray-scale graphical image is compressed, said compression method comprises the steps of:
subdividing the graphical image into cells containing 4×4 pixels,
determining an average cell color for each cell,
in the case that the average cell color is a gray-scale color, 1 bit is used to mark the cell as gray scaled and 7 bits are used to represent the gray-scale color, or
in the case that the average cell color is not a gray-scale color, 1 bit is used to mark the cell as non-gray scaled and 15 bits are used to represent the color.

31. A method according to claim 10, wherein an RGB-color graphical image or a gray-scale graphical image is compressed, said compression method comprises the steps of:
subdividing the graphical image into cells containing 4×4 pixels,
determining an average cell color for each cell,
in the case that the average cell color is a gray-scale color, 1 bit is used to mark the cell as gray scaled and 7 bits are used to represent the gray-scale color, or
in the case that the average cell color is not a gray-scale color, 1 bit is used to mark the cell as non-gray scaled and 15 bits are used to represent the color.
